(19) United States
(12) Patent Application Publication
(10) Pub. No.: US 2012/0272184 A1
(43) Pub. Date: Oct. 25, 2012

(54) APPARATUS AND METHOD FOR EDITING VIRTUAL SPACE IN TERMINAL

(75) Inventors: Jae-Won CHO, Suwon-si (KR); Kyoung-Yong LEE, Suwon-si (KR)

(73) Assignee: Samsung Electronics Co., Ltd., Suwon-si (KR)

(21) Appl. No.: 13/451,003

(22) Filed: Apr. 19, 2012

Related U.S. Application Data
(60) Provisional application No. 61/477,012, filed on Apr. 19, 2011.

(30) Foreign Application Priority Data
Apr. 13, 2012 (KR) 10-2012-0038307

(51) Int. Cl. G06F 3/048

(52) U.S. Cl. 715/786; 715/781

(57) ABSTRACT

An apparatus and method for editing a virtual space in a terminal are provided. The apparatus includes a display, and a controller for displaying a parent resource including a first control and a first subresource when editing a virtual space that is larger than a display area of the display, displaying the first subresource including a second control and a second subresource when editing of the first subresource is requested, and reflecting an edited portion in at least one of the parent resource and the first subresource.

### PRIORITY

This application claims priority under 35 U.S.C. §119 to a U.S. Provisional Patent Application Ser. No. 61/477,012, which was filed in the United States Patent and Trademark Office on Apr. 19, 2011, and Korean Patent Application Serial No. 10-2012-0038307, which was filed in the Korean Intellectual Property Office on Apr. 13, 2012, the entire disclosure of each of which are incorporated herein by reference.

### BACKGROUND OF THE INVENTION

1. Field of the Invention

The present invention relates generally to a terminal, and more particularly, to an apparatus and method for editing a virtual space in the terminal.

2. Description of the Related Art

Recently, with the generalization of multi-touch based input technologies, many controls considering a touch environment in a mobile platform have been developed.

For example, a user interface design tool of the mobile platform may design a control in the form of WYSIWYG (What You See is What You Get).

However, if content of a control to be designed is a virtual space having a larger region than an actual screen size of a portable terminal, the user interface design tool directly writes a code for the content to design a user interface screen.

The user interface design tool is intended to display an image that is actually to be displayed on the screen of the portable terminal, and to easily dispose a control. However, when the virtual space has a larger region than the actual screen, it cannot be supported by the user interface design tool, thereby making it difficult to predict the image that is actually to be displayed on the screen. Further, when the virtual space is edited, a user directly writes code, increasing a time for editing.

### SUMMARY OF THE INVENTION

Accordingly, the present invention is designed to address at least the problems and/or disadvantages described above and to provide at least the advantages described below.

An aspect of the present invention is to provide an apparatus and method for easily editing a virtual space that is larger than a screen of a terminal.

In accordance with an aspect of the present invention, an apparatus is provided for editing a virtual space in a terminal. The apparatus includes a display and a controller for displaying a parent resource including a first control and a first subresource when editing a virtual space that is larger than a display area of the display, displaying the first subresource including a second control and a second subresource when editing of the first subresource is requested, and reflecting an edited portion in at least one of the parent resource and the first subresource.

In accordance with another aspect of the present invention, a method for editing a virtual space in a terminal is provided. The method includes displaying a parent resource including a first control and a first subresource when editing the virtual space that is a larger than a display area, displaying the first subresource including a second control and a second subresource, if editing of the first subresource is requested, and reflecting an edited region in at least one of the parent resource and the first subresource.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a block diagram illustrating a terminal according to an embodiment of the present invention;

FIG. 2 is a flowchart illustrating a process of editing a virtual space in a terminal according to an embodiment of the present invention; and

FIGS. 3 and 4 illustrate screens for editing a virtual space in a terminal according to an embodiment of the present invention.

### DETAILED DESCRIPTION OF EMBODIMENTS OF THE PRESENT INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

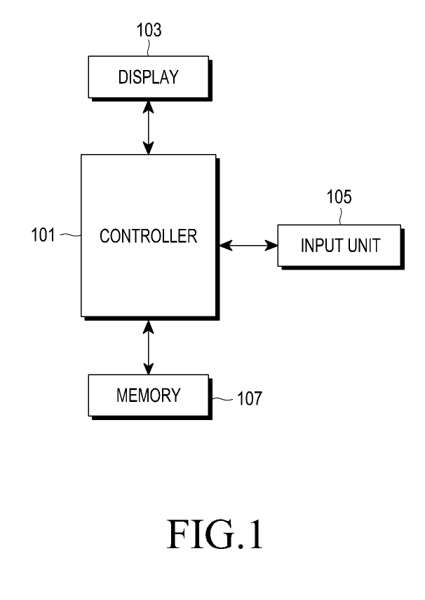

FIG. 1 is a block diagram illustrating a terminal according to an embodiment of the present invention. The terminal may be a portable terminal or a fixed terminal. Examples of a portable terminal include a video phone, a smart phone, an International Mobile Telecommunication (IMT)-2000 terminal, a Wideband Code Division Multiple Access (WCDMA) terminal, a Universal Mobile Telecommunication Service (UMTS) terminal, a Personal Digital Assistant (PDA), a Portable Multimedia Player (PMP), a Digital Multimedia Broadcasting (DMB) terminal, an Electronic (E) book, a portable computer (e.g., a notebook, a tablet, etc.), a digital camera, etc. Examples of a fixed terminal include a desktop personal computer, etc.

Referring to FIG. 1, the terminal includes a controller 101, a display 103, an input unit 105, and a memory 107. The input unit 105, which may be a touch screen, receives inputs from a user, and the display unit 103, for example, an Liquid Crystal Display, displays information, e.g., images, text, etc.

The memory 107 stores programs, e.g., booting and Operation System (OS) for controlling general operations of the terminal, and data generated during the operation of the terminal.

The controller 101 controls the overall operation of the terminal. Specifically, the controller 101 checks if editing of a virtual space is requested by a user of the terminal after execution of a user interface design tool. Herein, the virtual space has a larger size than a visible region on the display 103 of the terminal, and includes at least one parent resource.

If editing of the virtual space is requested, the controller 101 displays at least one parent resource on the display 103. For example, the parent resource may be displayed in a preset first region of the screen, and may include a control and a first subresource. Herein, a parent resource refers to a region of the virtual space, which is visible on the screen, and a subresource refers to a region of the virtual space, which is not visible on the screen. As such, the region that is visible on the screen and the region that is not visible on the screen may be displayed in the form of WYSIWYG.

Further, the control refers to a region in which an image included in the virtual space can be changed by the user. For example, upon a user selecting the control, an image corresponding to the selected control is output in the virtual space. The first subresource is displayed on a preset second region included in the first region, and may have a larger size than a region displayed on the screen.

After the parent resource is displayed, the controller 101 checks if a portion of a region of the parent resource is edited by the user. If the particular portion of the region of the parent resource is edited, the controller 101 immediately reflects the edited portion in the parent resource. The controller 101 also checks if editing of the first subresource is requested by the user.

If editing of the first subresource is requested, the controller 101 displays the parent resource including an editing window of the first subresource on the display 103. If the first subresource has a larger size than can be displayed on the display 103, the controller 101 displays a scroll bar within the editing window of the first subresource. The user may move a region of the first subresource by moving the displayed scroll bar. Herein, the first subresource may include at least one control and at least one second subresource.

After the editing window of the first subresource is displayed, the controller 101 checks if a portion of a region of a first subresource is edited by the user. If the portion of the region of the first subresource is edited, the controller 101 immediately reflects the edited portion in the parent resource and the first subresource.

The controller 101 terminates editing of the virtual space, e.g., when ended by a user command.

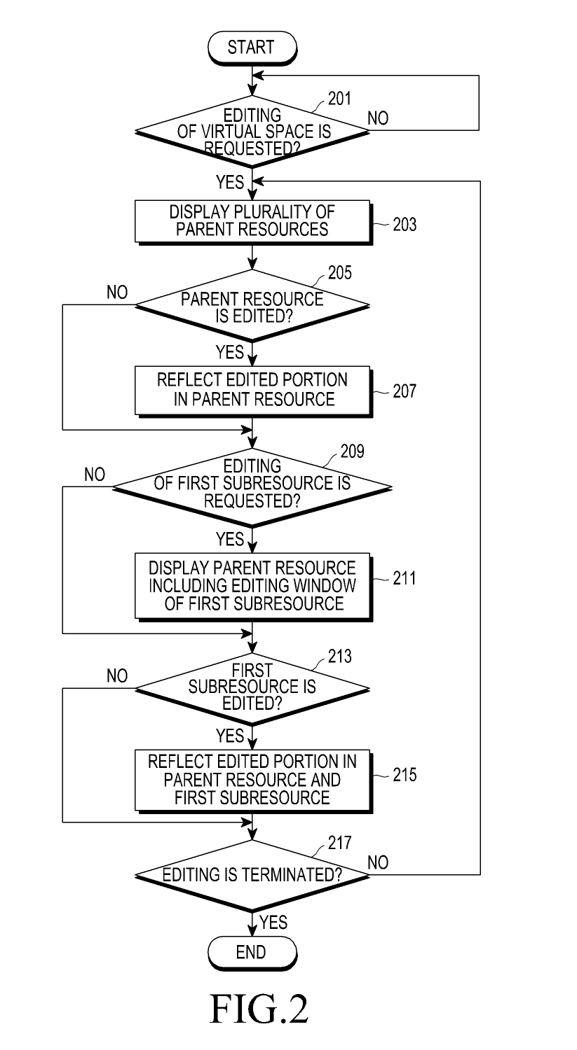

FIG. 2 is a flowchart illustrating a process of editing a virtual space in a terminal according to an embodiment of the present invention.

Referring to FIG. 2, in step 201, the controller 101 determines if editing of the virtual space is. Herein, the virtual space includes at least one parent resource and is larger than a region displayed on the display 103. When editing of the virtual space is requested, in step 203, the controller 101 displays the at least one parent resource in a preset first region of the screen. The parent resource may include at least one control and at least one first subresource. As described above, the control refers to a region in which an image included in the virtual space can be changed by the user.

In step 205, the controller 101 determines if a particular portion of the region of the parent resource is edited by the user. When the particular portion of the region of the parent resource is edited, in step 207, the controller 1010 immediately reflects the edited portion in the parent resource.

After step 207 or when the controller 101 determines that the particular portion of the region of the parent resource is not edited 205, the controller 101 determines if editing of the first subresource is requested by the user in step 209. When editing of the first subresource is requested, in step 211, the controller 101 displays the parent resource including the editing window of the first subresource. As described above, if the first subresource is larger than a region where it is to be displayed on the display 103, the controller 101 displays a scroll bar in the editing window of the first subresource. Herein, the first subresource may include at least one control and at least one second subresource.

After step 211 or when the controller 101 determines editing of the first subresource is not requested, the controller 101 determines if a portion of the region of the first subresource is edited by the user in step 213. When the portion of the region of the first subresource is edited by the user, in step 215, the controller 101 immediately reflects the edited portion in the parent resource and the first subresource.

After step 215 or when the controller determines that the portion of the region of the first subresource is not edited by the user in step 213, the controller 101 checks if termination of editing is requested by the user in step 217 When termination of the editing is requested, the controller 101 terminates editing of the virtual space; otherwise, the operation returns to step 203.

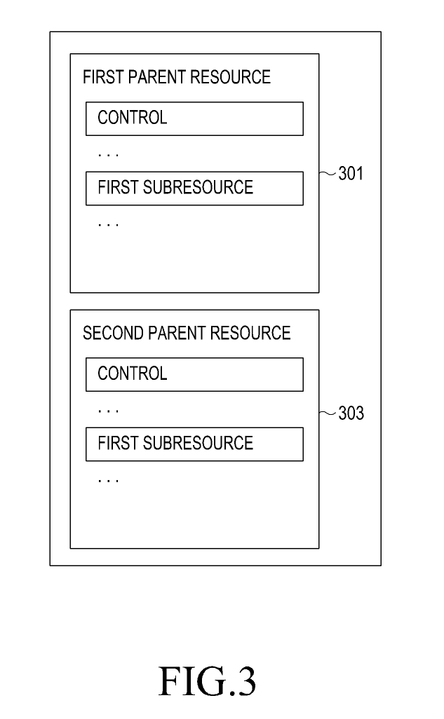

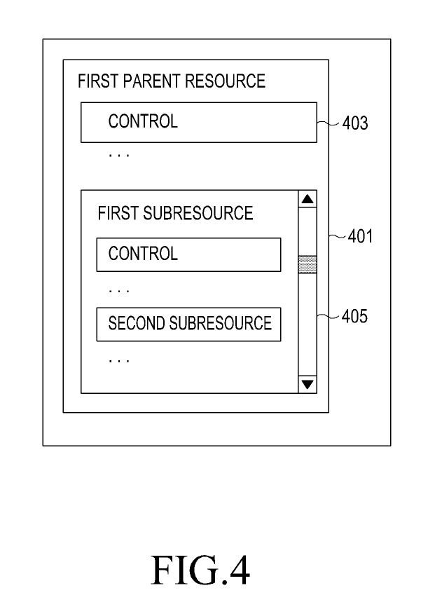

FIGS. 3 and 4 illustrate screens for editing a virtual space in a terminal according to an embodiment of the present invention.

Referring to FIG. 3, when editing of the virtual space is requested by the user, the terminal outputs a screen including a plurality of parent resources 301 and 303. Again, the parent resource is displayed in the preset first region of the screen, and may include at least one control and at least one first subresource.

When a user requests editing of the first subresource included in a first parent resource among the plurality of parent resources 301 and 303, the controller 101 outputs a first parent resource 401, which includes an editing window 405 of the first subresource whose editing is requested and a control 403.

As illustrated in FIG. 4, the editing window 405 includes a scroll bar, with which the user may move the region of the first subresource. For example, the editing of the first subresource may be requested by double-clicking the first subresource or selecting a menu for requesting editing of the first subresource.

As is apparent from the foregoing description, the above-described embodiments of the present invention provide an apparatus and method for easily editing a virtual space by separately displaying a virtual space that is larger than the screen of the terminal as a region that is visible on the screen and the region that is not visible on the screen.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. An apparatus for editing a virtual space in a terminal, the apparatus comprising:
a display; and
a controller for displaying a parent resource including a first control and a first subresource when editing a virtual space that is larger than a display area of the display, displaying the first subresource including a second control and a second subresource when editing of the first subresource is requested, and reflecting an edited portion in at least one of the parent resource and the first subresource.

2. The apparatus of claim 1, wherein the first subresource is larger than the display area of the display.

3. The apparatus of claim 1, wherein the controller outputs a scroll bar for moving the first subresource.

4. The apparatus of claim 1, wherein the parent resource is displayed in a preset first region.

5. The apparatus of claim 4, wherein the first subresource is displayed on a preset second region of the preset first region.

6. A method for editing a virtual space in a terminal, the method comprising:
displaying a parent resource including a first control and a first subresource when editing the virtual space that is a larger than a display area;
displaying the first subresource including a second control and a second subresource, if editing of the first subresource is requested; and
reflecting an edited region in at least one of the parent resource and the first subresource.

7. The method of claim 6, wherein the first subresource is larger than the display area.

8. The method of claim 6, wherein displaying the first subresource comprises outputting a scroll bar for moving a region of the first subresource.

9. The method of claim 6, wherein the parent resource is displayed in a preset first region.

10. The method of claim 9, wherein the first subresource is displayed on a preset second region of the preset first region.
